(19) United States
(12) Patent Application Publication
(10) Pub. No.: US 2026/0186895 A1
(43) Pub. Date: Jul. 2, 2026

(54) MULTI BIT CORRECTION BASED RAS FOR MEMORY DEVICES

(71) Applicant: Micron Technology, Inc., Boise, ID (US)

(72) Inventors: Marco Sforzin, Cernusco Sul Naviglio MI (IT); Su Wei Lim, Bayan Lepas (MY)

(21) Appl. No.: 19/394,250

(22) Filed: Nov. 19, 2025

Related U.S. Application Data
(60) Provisional application No. 63/740,612, filed on Dec. 31, 2024.

(51) Int. Cl. G06F 11/10

(52) U.S. Cl. CPC G06F 11/1004

(57) ABSTRACT

Systems and methods are disclosed, including a memory system that includes a memory array and a memory controller. The memory array includes memory cells that are included in multiple memory dies. The memory controller includes a cyclic redundancy check (CRC) encoder configured to determine a CRC code using a data word received by the memory controller; and a Bose-Chaudri-Hocqenghem (BCH) encoder configured to determine a BCH code using the data word and the CRC code. The memory controller is configured to store the data word in the memory array and store the BCH code and the CRC code in the memory array in association with the data word.

### PRIORITY APPLICATION

This application claims the benefit of priority to U.S. Provisional Application Ser. No. 63/740,612, filed Dec. 31, 2024, which is incorporated herein by reference in its entirety.

### BACKGROUND

Memory devices are semiconductor circuits that provide electronic storage of data for a host system (e.g., a computer or other electronic device). Memory devices may be volatile or non-volatile. Volatile memory requires power to maintain data and includes devices such as random-access memory (RAM), static random-access memory (SRAM), dynamic random-access memory (DRAM), or synchronous dynamic random-access memory (SDRAM), among others.

Host systems (or hosts) typically include a host processor, a first amount of main memory (e.g., often volatile memory, such as DRAM) to support the host processor, and one or more memory systems (e.g., often non-volatile memory, such as flash memory, and may include volatile memory) that provide additional storage to retain data in addition to or separate from the main memory.

A memory system can include a memory controller and one or more memory devices, including a number of dies or logical units (LUNs). In certain examples, each die can include a number of memory arrays and peripheral circuitry thereon, such as die logic or a die processor. The memory controller can include interface circuitry configured to communicate with a host (e.g., the host processor or interface circuitry) through a communication link (e.g., a bidirectional parallel or serial communication interface). The memory controller can receive commands or operations from the host system in association with memory operations or instructions, such as read or write operations to transfer data (e.g., user data and associated integrity data, such as error data or address data, etc.) between the memory devices and the host, erase operations to erase data from the memory devices, perform drive management operations (e.g., data migration, garbage collection, block retirement), etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example computing system including a host system and a memory system.

FIG. 2 is a block diagram of portions of an example of a memory system.

FIG. 3 is a diagram of an example of a prefetch of memory data from multiple memory dies with a first type of overprovisioning.

FIG. 4 is a diagram of an example of a prefetch of memory data from multiple memory dies with reduced overprovisioning.

FIG. 5 is a block diagram of portions of another example of a memory system.

FIG. 6 is a flow diagram of an example of a method of operating a memory system.

FIG. 7 illustrates an example block diagram of a computing system.

### DETAILED DESCRIPTION

Software (e.g., programs), instructions, operating systems (OS), and other data are typically stored on storage systems and accessed for use by a host processor. Main memory (e.g., RAM) is typically faster, more expensive, and a different type of memory device (e.g., volatile) than a majority of the memory devices of the memory system (e.g., non-volatile, such as an SSD, etc.). In addition to the main memory, host devices can include different levels of volatile memory, such as a group of static memory (e.g., a cache, often SRAM), often faster than the main memory, in certain examples, configured to operate at speeds close to or exceeding the speed of the host processor, but with lower density and higher cost. Systems can include high speed, low latency compute express link (CXL) compatible memory. The CXL compatible memory provides a high capacity link between processors and the memory system.

Memory devices include individual memory die, which may, for example, include including a storage region comprising one or more arrays of memory cells, implementing one (or more) selected storage technologies. Such memory die will often include support circuitry for operating the memory array(s). Other examples, sometimes known generally as “managed memory devices,” include assemblies of one or more memory die associated with controller functionality configured to control operation of the one or more memory dies. Such controller functionality can simplify interoperability with an external host device. In such managed memory devices, the controller functionality may be implemented on one or more dies also incorporating a memory array, or on a separate die. In other examples, one or more memory devices may be combined with controller functionality to form a solid-state drive (SSD) storage volume.

Embodiments of the present disclosure are described in the example of managed memory devices implementing NAND flash memory cells. These examples can be referred to as managed NAND or mNAND devices. These examples, however, are not limited to the scope of the disclosure, which may be implemented in other forms of memory devices and/or with other forms of storage technology.

Both NOR and NAND flash architecture semiconductor memory arrays are accessed through decoders that activate specific memory cells by selecting the word line coupled to their gates. In a NOR architecture semiconductor memory array, once activated, the selected memory cells place their data values on bit lines, causing different currents to flow depending on the state at which a particular cell is programmed. In a NAND architecture semiconductor memory array, a high bias voltage is applied to a drain-side select gate (SGD) line. Word lines coupled to the gates of the unselected memory cells of each group are driven at a specified pass voltage (e.g., Vpass) to operate the unselected memory cells of each group as pass transistors (e.g., to pass current in a manner unrestricted by their stored data values). Current then flows from the source line to the bit line through each series coupled group, restricted only by the selected memory cells of each group, placing current encoded data values of selected memory cells on the bit lines.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can also represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices may be configured and operated in accordance with recognized industry standards. For example, managed NAND devices may be (as non-limiting examples), a Universal Flash Storage (UFS™) device, or an embedded MMC device (eMMC™), etc. For example, in the case of the above examples, UFS devices may be configured in accordance with Joint Electron Device Engineering Council (JEDEC) standards (e.g., JEDEC standard JESD223D, entitled JEDEC UFS Flash Storage 3.0, etc., and/or updates or subsequent versions to such standard. Similarly, identified eMMC devices may be configured in accordance with JEDEC standard JESD84-A51, entitled “JEDEC eMMC standard 5.1”, again, and/or updates or subsequent versions to such standard.

An SSD can be used as, among other things, the main storage device of a computer, having advantages over traditional hard drives with moving parts with respect to, for example, performance, size, weight, ruggedness, operating temperature range, and power consumption. For example, SSDs can have reduced seek time, latency, or other delay associated with magnetic disk drives (e.g., electromechanical, etc.). SSDs use non-volatile memory cells, such as flash memory cells to obviate internal battery supply requirements, thus allowing the drive to be more versatile and compact. Managed memory devices, for example managed NAND devices, can be used as primary or ancillary memory in various forms of electronic devices, and are commonly used in mobile devices.

Managed memory devices can include a number of memory devices, including a number of dies or logical units (e.g., logical unit numbers or LUNs), and can include one or more processors or other controllers performing logic functions required to operate the memory devices or interface with external systems. Such managed memory devices can include one or more flash memory dies, including a number of memory arrays and peripheral circuitry thereon. The flash memory arrays can include a number of blocks of memory cells organized into a number of physical pages. Managed NAND devices can include one or more arrays of volatile and/or nonvolatile memory separate from the NAND storage array, and either within or separate from a controller. Both SSDs and managed NAND devices can receive commands from a host or a host in association with memory operations, such as read or write operations to transfer data (e.g., user data and associated integrity data, such as error data and address data, etc.) between the memory devices and the host, or erase operations to erase data from the memory devices.

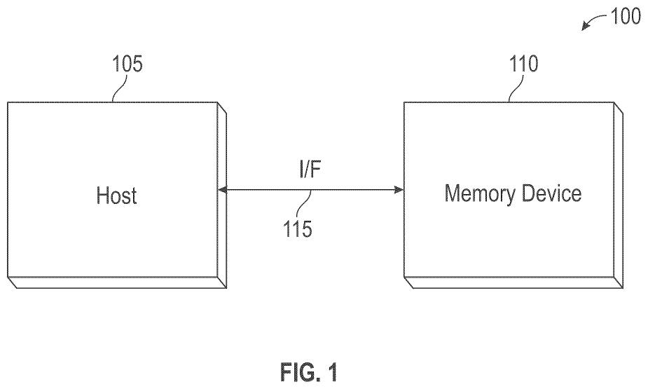

FIG. 1 illustrates an example computing system 100 including a host system or host 105 and a memory system 110. The host 105 can include a host processor, a central processing unit, or one or more other devices, processors, or controllers. The memory system 110 can include one or more other memory devices, and the communication interface 115 (I/F) can include one or more other interfaces, depending on the host 105 and the memory system 110. Each of the host 105 and the memory system 110 can include a number of receiver or driver circuits configured to send or receive signals over the communication interface 115, or interface circuits, such as data control units, sampling circuits, or other intermedia circuits configured to process data to be communicated over, or otherwise process data received from the communication interface 115 for use by the host 105, the memory system 110, or one or more other circuits or devices.

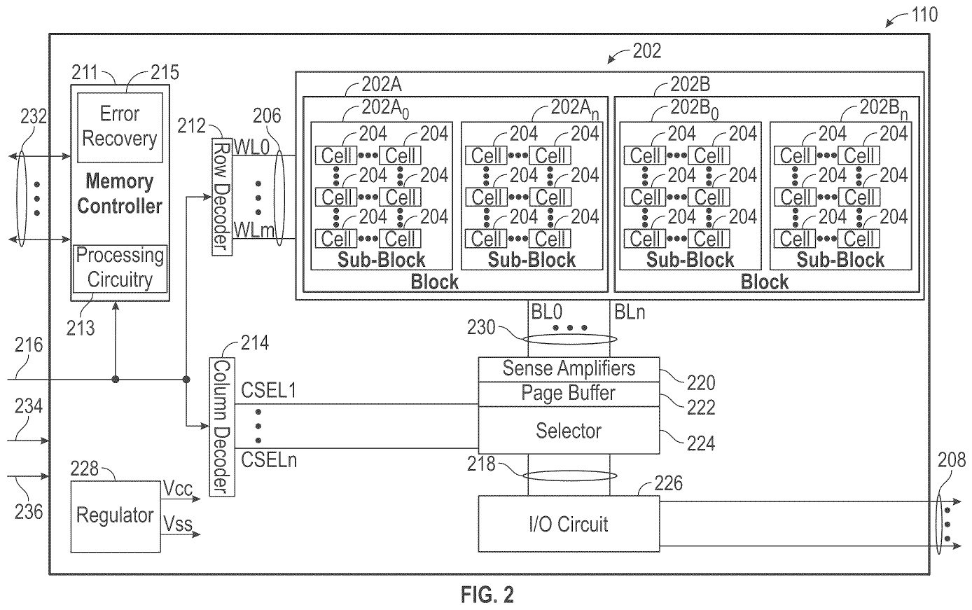

FIG. 2 illustrates an example block diagram of portions of a memory system 110 including a memory array 202 having a plurality of memory cells 204, and one or more circuits or components to provide communication with, or perform one or more memory operations on, the memory array 202. Although shown with a single memory array 202, in other examples, one or more additional memory arrays, dies, or LUNs can be included herein. The memory system 110 can include a row decoder 212, a column decoder 214, sense amplifiers 220, a page buffer 222, a selector 224, an input/output (I/O) circuit 226, and a memory controller 211.

The memory cells 204 of the memory array 202 can be arranged in blocks, such as first and second blocks 202A, 202B. Each block can include sub-blocks. For example, the first block 202A can include first and second sub-blocks 202A₀, 202Aₙ, and the second block 202B can include first and second sub-blocks 202B₀, 202Bₙ. Each sub-block can include a number of physical pages, each page including a number of memory cells 204. Although illustrated herein as having two blocks, each block having two sub-blocks, and each sub-block having a number of memory cells 204, in other examples, the memory array 202 can include more or fewer blocks, sub-blocks, memory cells, etc. In other examples, the memory cells 204 can be arranged in a number of rows, columns, pages, sub-blocks, blocks, etc., and accessed using, for example, access lines 206, first data lines 230, or one or more select gates, source lines, etc.

The memory controller 211 can control memory operations of the memory system 110 according to one or more signals or instructions received on control lines 232, including, for example, one or more clock signals or control signals that indicate a desired operation (e.g., write, read, erase, etc.), or address signals (A0-AX) received on one or more address lines 216. One or more devices external to the memory system 110 can control the values of the control signals on the control lines 232, or the address signals on the address line 216. Examples of devices external to the memory system 110 can include, but are not limited to, a host, a memory controller, a processor, or one or more circuits or components not illustrated in FIG. 2.

The memory system 110 can use access lines 206 and first data lines 230 to transfer data to (e.g., a write or erase operation) or from (e.g., a read operation) one or more of the memory cells 204. The row decoder 212 and the column decoder 214 can receive and decode the address signals (A0-AX) from the address line 216, can determine which of the memory cells 204 are to be accessed, and can provide signals to one or more of the access lines 206 (e.g., one or more of a plurality of word lines (WL0-WLm)) or the first data lines 230 (e.g., one or more of a plurality of bit lines (BL0-BLn)), such as described above.

The memory system 110 can include sense circuitry, such as the sense amplifiers 220, configured to determine the values of data on (e.g., read), or to determine the values of data to be written to, the memory cells 204 using the first data lines 230. For example, in a selected string of memory cells 204, one or more of the sense amplifiers 220 can read a logic level in the selected memory cell 204 in response to a read current flowing in the memory array 202 through the selected string to the data lines 230.

One or more devices external to the memory system 110 can communicate with the memory system 110 using the I/O lines (DQ0-DQN) 208, address lines 216 (A0-AX), or control lines 232. The input/output (I/O) circuit 226 can transfer values of data in or out of the memory system 110, such as in or out of the page buffer 222 or the memory array 202, using the I/O lines 208, according to, for example, the control lines 232 and address lines 216. The page buffer 222 can store data received from the one or more devices external to the memory system 110 before the data is programmed into relevant portions of the memory array 202 or can store data read from the memory array 202 before the data is transmitted to the one or more devices external to the memory system 110.

The column decoder 214 can receive and decode address signals (A0-AX) into one or more column select signals (CSEL1-CSELn). The selector 224 (e.g., a select circuit) can receive the column select signals (CSEL1-CSELn) and select data in the page buffer 222 representing values of data to be read from or to be programmed into memory cells 204. Selected data can be transferred between the page buffer 222 and the I/O circuit 226 using second data lines 218.

The memory system 110 can receive positive and negative supply signals, such as a supply voltage (Vcc) 234 and a negative supply (Vss) 236 (e.g., a ground potential), from an external source or supply (e.g., an internal or external battery, an AC-to-DC converter, etc.). In certain examples, the memory system 110 can include a regulator 228 to internally provide positive or negative supply signals.

In FIG. 2, the memory controller 211 includes controller processing circuitry 213 to perform the functions described for the memory controller 211. The controller processing circuitry 213 can include one or more processors (e.g., microprocessors), an application specific integrated circuit (ASIC), or programmable gate array (PGA).

Some memory systems incorporate Reliability, Availability, and Serviceability (RAS) features to minimize downtime by detecting and repairing memory errors. One type of RAS feature is chip kill, which provides error checking and correcting to protect the memory system from single memory die failures and multi-bit errors from a memory die. Chip kill typically involves overprovisioning of data bits by using extra data bits for error detection and correction algorithms. The overprovisioning may add 25% to the number of bits used for a data word.

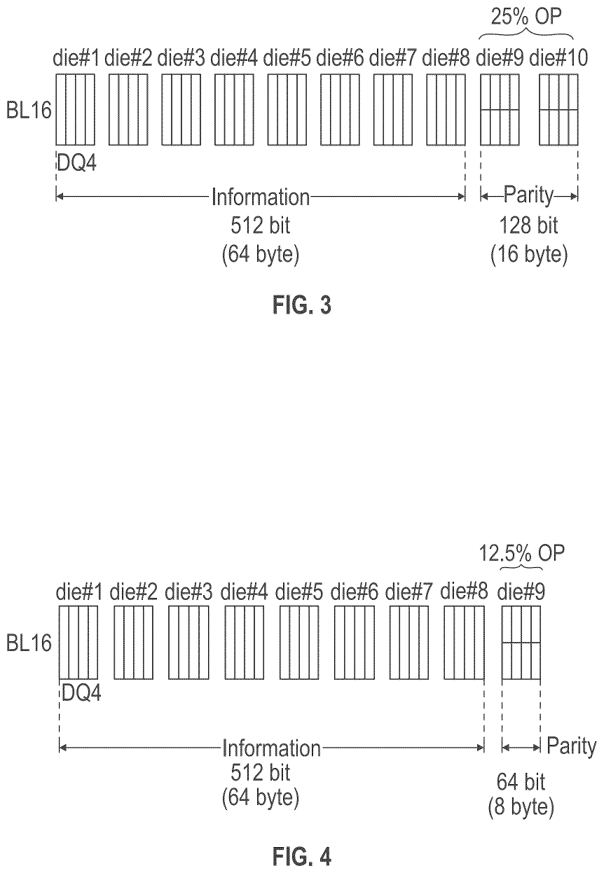

FIG. 3 is a diagram of an example of a prefetch of memory data from multiple memory dies. The memory dies are numbered die 1 through die 10. A 64 byte or 512 bit data access uses dies 1-8 and dies 9-10 provide 16 bytes for error protection for the data access. FIG. 2 shows that the memory controller 211 includes error recovery circuitry 215 to detect errors in memory data. In an example, the error recovery circuitry 215 may use Read-Solomon (RS) encoding for data protection. For instance, a memory read would read 64 bytes of data in parallel from dies 1-8 and read 16 bytes of RS information for chip kill recovery from dies 9 and 10. Thus, 25% overprovisioning (OP) is used for chip kill. A memory write would write 64 bytes of data in parallel to the memory dies 1-8 and write 16 bytes of RS information for chip kill to dies 9 and 10. The 16 bytes of RS information provides correction capability for an entire memory die. Each 64 bytes data word in memory is stored as a codeword that is the data word plus parity bits. Each codeword is grouped into bits called symbols and the symbols are evenly striped across the memory dies. The parity bits of dies 9 and 10 allow the RS algorithm to correct one bad symbol per codeword and detect two bad symbols per codeword. If the codewords are grouped as four symbols, any of the four symbols can be corrected if it is bad, and errors can be detected in any two of the symbols.

FIG. 4 is a diagram of another example of a prefetch of memory data from multiple memory dies. The example of FIG. 4 uses one half the number of bytes (8 bytes) for error protection that are used in the example of FIG. 3 and only one memory die (die 9) is used to store RS information. Because the number of bytes is one half than in the example of FIG. 3, the example of FIG. 4 uses 12.5% OP. The cost of the reduced OP is reduced error correction. The 8 bytes of RS information provides correction capability for one half of a memory die. Thus, the approach of FIG. 4 does not provide chip kill recovery.

Another approach to error protection uses Bose-Chaudri-Hocqenghem (BCH) coding. BCH coding involves determining BCH codes for data words stored in the memory. BCH codes can provide correction of multiple errors in the data words. BCH codes are cyclic codes with design distance d of d=2t+1, where t is the number of errors to correct. A primitive binary BCH code C has the parameters N (length of C) and K (dimension of C), wherein N=2^{m}−1 and K=N−mt. The number of parity bits included in a BCH codeword is mt. Shortening of BCH codewords can be used to match the data payload of memory from a primitive BCH code. The length n and dimension k of the BCH code after shortening is n=N−s, and k=K−s, where s is the number of bits fixed to zero in the shortening.

Shortened primitive codes can be determined for the memory word with 12.5% OP in FIG. 4. For the example of FIG. 4, k=512, where 512 is the number of bits to protect from errors. The smallest m allowing a shortening for this k dimension is m=10. The number of parity bits needed for t errors to correct is 10t. Table 1 shows examples of the total number of bits to store for different values of t.

TABLE 1

| | mt | n | k |
|---|---|---|---|
| BCH2 | 20 | 532 | 512 |
| BCH3 | 30 | 542 | 512 |
| BCH4 | 40 | 552 | 512 |
| BCH5 | 50 | 562 | 512 |
| BCH6 | 60 | 572 | 512 |

The rows in Table 1 are BCH codes for different values of t. For example, BCH2 refers to using a BCH with t=2, and BCH6 refers to using a BCH with t=6. The columns show the number of bits in the BCH code (mt), the number of bits in the data word (k), and total number of bits (n) of data plus BCH code where n=k+mt.

The BCH codes can be extended by adding extra bits. A BCH code can be extended to detect one additional error (t+1) by including a single parity bit with the BCH code. Table 2 shows examples of extended BCH codes (eBCH) for t=2 to t=6.

TABLE 2

| | mt + 1 | n | k |
|---|---|---|---|
| eBCH2 | 21 | 533 | 512 |
| eBCH3 | 31 | 543 | 512 |
| eBCH4 | 41 | 553 | 512 |
| eBCH5 | 51 | 563 | 512 |
| eBCH6 | 61 | 573 | 512 |

For the example of FIG. 4 there are 64 bits available for 12.5% OP. The BCH codes and eBCH codes in the examples of Tables 1 and 2 vary in length from 20 to 61. For the BCH codes, there are 64−mt bits remaining for use, and for the eBCH codes there are 64-mt-1 bits remaining for use. The remaining bits are used for Cyclic Redundancy Check encoding.

Table 3 shows an example of BCH codes and eBCH codes and bits used for CRC codes for 12.5% OP. In some examples, the 64−mt bits or 64−mt−1 bits include metadata (MD) and MD+CRC=64−mt bits or 64−mt−1. For instance, if there is one bit of metadata and eBCH3 is used for the extended BCH code, the 64 bits of OP in die #9 of FIG. 4 includes 31 bits of eBCH3, 32 bits of CRC, and 1 bit of MD. The metadata can be produced by the memory controller 211. The BCH codes and CRC are stored in association with the data words are used to detect and correct errors in the data words.

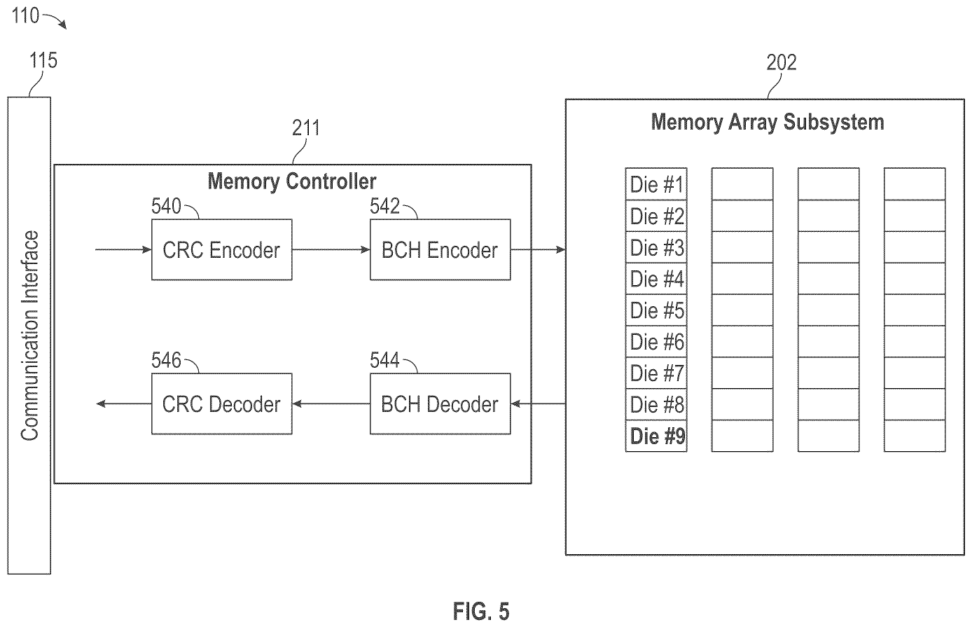

FIG. 5 is a block diagram of portions of an example of a memory system 110 including a portion of a memory array subsystem 202, communication interface 115, and memory controller 211. The memory system 110 may be included in a CXL device and the communication interface 115 receives data words according to a CXL compatible protocol. The memory array subsystem 202 shows one memory channel that includes four memory ranks. The memory ranks each include nine memory dies as in the example of FIG. 4. Die #9 stores OP information for error recovery.

TABLE 3

| | ECC | 64 − ECC | CRC |
|---|---|---|---|
| BCH2 | 20 | 44 | CRC44 |
| BCH3 | 30 | 34 | CRC34 |
| BCH4 | 40 | 24 | CRC24 |
| BCH5 | 50 | 14 | CRC14 |
| BCH6 | 60 | 4 | CRC4 |
| eBCH2 | 21 | 43 | CRC43 |
| eBCH3 | 31 | 33 | CRC33 |
| eBCH4 | 41 | 23 | CRC23 |
| eBCH5 | 51 | 13 | CRC13 |
| eBCH6 | 61 | 3 | CRC3 |

Data words are received by the memory system 110 via the communication interface 115, such as from a host 105 for example. The error recovery circuitry of the memory controller 211 includes a CRC encoder 540 and a BCH encode 542. The memory controller 211 also includes a BCH decoder 544 and a CRC decoder 546. The CRC encoder 540, the BCH encoder 542, the BCH decoder 544, and the CRC decoder may be implemented in combinational logic circuitry.

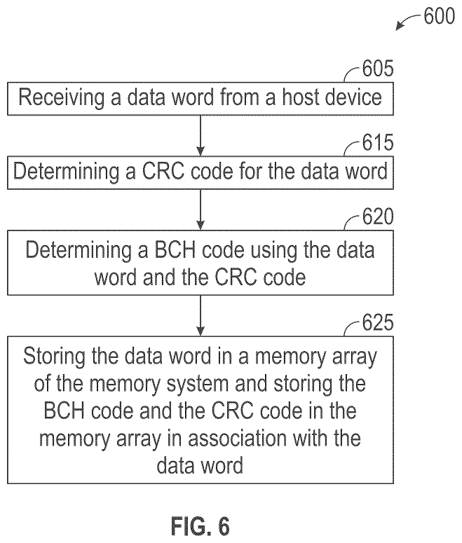

FIG. 6 is a flow diagram of an example of a method of operating a memory system, such as the memory system 110 of FIG. 5 for example. At block 605, the memory controller 211 receives a data word via the communication interface 115. At block 610, the CRC encoder 540 produces a CRC code using the received data word. At block 615, the BCH encoder 542 produces a BCH code using the data word and the CRC code. At block 620, the memory controller 211 stores the data word in a memory rank in association with the CRC code and BCH code. For instance, the memory controller 211 may store the data word in Dies #1-#8 and store the CRC code and BCH code in Die #9 as in the example of FIG. 4.

When the memory controller 211 performs a read operation, such as a prefetch operation, the memory controller 211 reads the BCH code and CRC code stored for the data word. The BCH code is provided to the BCH decoder 544 to detect any errors in writing and reading the data word and the CRC code in the memory rank. The CRC code is provided to the CRC decoder 546. The memory controller 211 checks for any errors in the data word using the BCH code and the CRC code.

The CRC encoder 540 and the BCH encode 542 may encode different combinations of BCH bits and CRC bits to fill the OP bits available as in the examples of Table 3. For example, the CRC encoder 540 may produce a 34 bit CRC code and the BCH encoder 542 may produce a 30 bit BCH code (BCH3) to fill the 64 bits of OP available in the example of FIG. 4. In another example, the CRC encoder 540 may produce a 24 bit CRC code and the BCH encoder 542 may produce a 40 bit BCH code (BCH4). Other combinations and permutations are possible. The CRC encoder 540 may produce two 12 bit CRC codes (one for each half of the data word) and the BCH encoder 542 may produce two 20 bit BCH codes (two BCH2 codes) for each half of the data word. The desired combination of BCH protection and CRC protection can be determined by the designer of the computing system using the memory system 110.

In further examples, the BCH encoder 542 determines an extended BCH code (eBCH code) using the data word and CRC code. The BCH encoder 542 encodes a BCH code and one or more parity bits in the eBCH code and the BCH decoder 544 checks for errors in the data word and CRC code using the BCH code and parity bits. The memory controller 211 may store metadata in association with the data word, CRC code, and BCH code. The BCH encoder 542 may determine the BCH code using the data word, the CRC code, and the metadata to protect the metadata from errors.

The memory controller 211 sends a response to a read operation to the source of the read operation (e.g., the host 105). The memory controller 211 sends the data word in the response when an error in the data word was not detected using the BCH code and CRC code, or when one or more errors were detected and corrected in the data word using the BCH code and CRC code. The memory controller 211 may send an error response when an uncorrectable error is detected using the BCH code and CRC code.

The devices and techniques described herein can provide Reliability, Availability and Serviceability (RAS) solutions for memory systems. The techniques providing RAS solutions utilize a reduced amount of overprovisioning from other approaches to RAS.

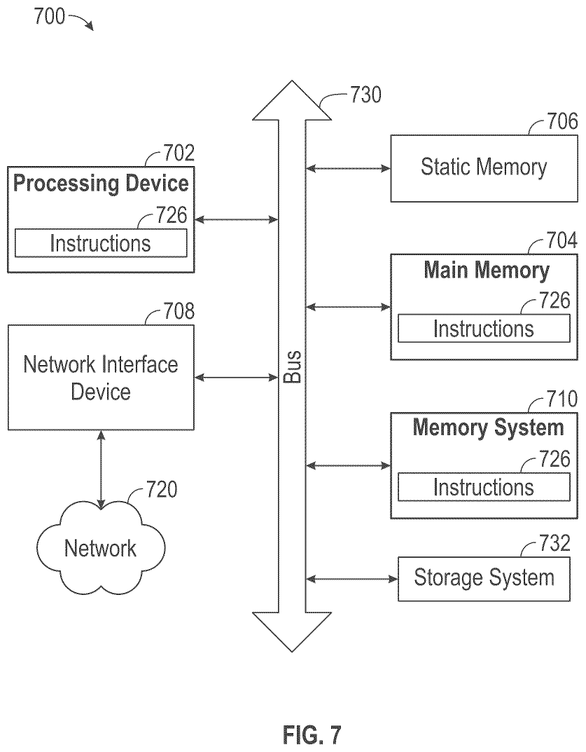

FIG. 7 illustrates a block diagram of an example machine 700 (e.g., a computing system) upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a network node. In an example, the machine 700 may act as a peer machine in a peer-to-peer (P2P) (or other distributed) network environment. The machine 700 may be a personal computer (PC), a tablet PC, a set-top box (STB), a personal digital assistant (PDA), a mobile telephone, a web appliance, an IoT device, an automotive computing system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 700 (e.g., computing system) may include a processing device 702 (e.g., a hardware processor, a central processing unit (CPU), a graphics processing unit (GPU), a hardware processor core, or any combination thereof, etc.), a main memory 704 (e.g., read-only memory (ROM), dynamic random-access memory (DRAM) such as synchronous DRAM (SDRAM) or Rambus DRAM (RDRAM), etc.), a static memory 706 (e.g., static random-access memory (SRAM), etc.), a memory system 718, and a storage system 732, some or all of which may communicate with each other via a communication interface (e.g., a bus) 730.

The processing device 702 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 can be configured to execute instructions 726 for performing the operations and steps discussed herein. The computer system can further include a network interface device 708 to communicate over a network 720.

The memory system 710 can include a machine-readable storage medium (also known as a computer-readable medium) on which is stored one or more sets of instructions 726 or software embodying any one or more of the methodologies or functions described herein. The instructions 726 can also reside, completely or at least partially, within the main memory 704 or within the processing device 702 during execution thereof by the computer system, the main memory 704 and the processing device 702 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 700 may further include a display unit, an alphanumeric input device (e.g., a keyboard), and a user interface (UI) navigation device (e.g., a mouse). In an example, one or more of the display units, the input device, or the UI navigation device may be a touch screen display. The machine may include a signal generation device (e.g., a speaker), or one or more sensors, such as a global positioning system (GPS) sensor, compass, accelerometer, or one or more other sensors. The machine 700 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 726 (e.g., software, programs, an operating system (OS), etc.) or other data stored on the storage system 718 can be accessed by the main memory 704 for use by the processing device 702. The main memory 704 (e.g., DRAM) is typically fast, but volatile, and thus a different type of storage than the storage system 718 (e.g., an SSD), which is suitable for long-term storage, including while in an “off” condition. The instructions 726 or data in use by a user or the machine 700 are typically loaded in the main memory 704 for use by the processing device 702. When the main memory 704 is full, virtual space from the memory system 718 can be allocated to supplement the main memory 704; however, because the memory system 718 device is typically slower than the main memory 704, and write speeds are typically at least twice as slow as read speeds, use of virtual memory can greatly reduce user experience due to storage system latency (in contrast to the main memory 704, e.g., DRAM). Further, use of the storage system 718 for virtual memory can greatly reduce the usable lifespan of the storage system 718.

The instructions 724 may further be transmitted or received over a network 720 using a transmission medium via the network interface device 708 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi©, IEEE 802.16 family of standards known as WiMax®, IEEE 802.15.4 family of standards, peer-to-peer (P2P) networks, among others). In an example, the network interface device 708 may include one or more physical jacks (e.g., Ethernet, coaxial, or phone jacks) or one or more antennas to connect to the network 720. In an example, the network interface device 708 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” (in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

In some embodiments described herein, different doping configurations may be applied to a select gate source (SGS), a control gate (CG), and a select gate drain (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (i.e., the memory cell may be programmed to an erased state).

According to one or more embodiments of the present disclosure, a memory controller (e.g., a processor, controller, firmware, etc.) located internal or external to a memory system, is capable of determining (e.g., selecting, setting, adjusting, computing, changing, clearing, communicating, adapting, deriving, defining, utilizing, modifying, applying, etc.) that a memory data error occurs during a memory operation and a memory system fault occurs. The memory controller may be configured to coordinate reporting of detection of memory data errors with detection of memory system faults.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 includes subject matter (such as a memory system) comprising a memory array and a memory controller. The memory array includes memory cells that are included in multiple memory die. The memory controller includes a cyclic redundancy check (CRC) encoder configured to determine a CRC code using a data word received by the memory controller, and a Bose-Chaudri-Hocqenghem (BCH) encoder configured to determine a BCH code using the data word and the CRC code. The memory controller is configured to store the data word in the memory array and store the BCH code and the CRC code in the memory array in association with the data word. The memory controller is configured to store the data word in the memory array and store the BCH code and the CRC code in the memory array in association with the data word.

In Example 2, the subject matter of Example 1 optionally includes a memory controller configured to prefetch, as part of a read operation, the stored data word and the CRC code and BCH code stored in association with the data word; perform error detection on the data word using the BCH code and the CRC code; and send a response to the read operation according to the error detection.

In Example 3, the subject matter of Example 2, optionally includes a memory controller that includes a BCH decoder configured to decode the BCH code stored in association with the data word; and a CRC decoder configured to decode the CRC code stored in association with the data word. The memory controller is optionally configured to perform error detection on the data word and CRC code using the decoded BCH code; and perform error detection on the data word using the CRC code when the BCH code indicates no errors in the CRC code.

In Example 4, the subject matter of one or both of Examples 2 and 3 optionally includes a memory controller configured to send the data word in the response to the read operation when an error in the data was not detected or when one or more errors were detected and corrected; and send an error indication in the response to the read operation when an uncorrectable error is detected using the BCH code and CRC code.

In Example 5, the subject matter of one or any combination of Examples 1-4 optionally includes a memory controller configured to store the BCH code and the CRC code in one memory die; and store the data word in one or more different memory die other than memory die storing the BCH code and the CRC code.

In Example 6, the subject matter of one or any combination of Examples 1-5 optionally includes a memory controller configured to store metadata in association with the data word; and a BCH encoder configured to determine the BCH code using the data word, the CRC code, and the metadata.

In Example 7, the subject matter of one or any combination of Examples 1-6 optionally includes a BCH encoder configured to determine an extended BCH code using the data word and the CRC code, wherein the extended BCH code includes a cyclic BCH codeword and a parity bit.

In Example 8, the subject matter of one or any combination of Examples 1-7 optionally includes a communication interface operatively coupled to the memory controller, and wherein the memory controller is optionally configured to receive the data word via the communication interface according to a compute express link (CXL) compatible protocol.

Example 9 includes subject matter (such as a method of operating a memory system) or can optionally be combined with one or any combination of Examples 1-8 to include such subject matter, comprising receiving, by a memory controller of the memory system, a data word from a host system; determining a cyclic redundancy check (CRC) code using the data word; determining a BCH code using the data word and the CRC code; and storing the data word in a memory array of the memory system and storing the BCH code and the CRC code in the memory array in association with the data word.

In Example 10, the subject matter of Example 9 optionally includes prefetching, by the memory controller in response to a read operation from the host system, the data word from the memory array and the BCH code and the CRC code stored in association with the data word; performing, by the memory controller, error detection on the data word using the BCH code and the CRC code; and sending a response to the host system according to the error detection.

In Example 11, the subject matter of Example 10 optionally includes decoding the BCH code; performing error detection on the data word and CRC code using the decoded BCH code; and performing error detection on the data word using the CRC code when the BCH code indicates no errors in the CRC code.

In Example 12, the subject matter of Example 11 optionally includes sending the data word when an error in the data word was not detected or when one or more errors were detected and corrected; and sending an error response to the host system when an uncorrectable error is detected using the BCH code and CRC code.

In Example 13, the subject matter of one or any combination of Examples 9-12 optionally includes storing the BCH code and the CRC code in a same memory die.

In Example 14, the subject matter of one or any combination of Examples 9-14 optionally includes storing, by the memory controller, metadata in association with the data word; and determining the BCH code using the data word, the CRC code, and the metadata.

In Example 15, the subject matter of one or any combination of Examples 9-14 optionally includes determining an extended BCH code using the data word and the CRC code, and the extended BCH code includes a cyclic BCH codeword and at least one parity bit.

In Example 16, the subject matter of one or any combination of Examples 9-15 optionally includes the memory controller receiving the data word from the host system according to a compute express link (CXL) compatible protocol.

Example 17 includes subject matter (such as a computing system) comprising a memory system and a host system. The memory system includes a memory array including memory cells that are included in multiple memory dies, and a memory controller operatively coupled to the memory dies. The host system includes host processing circuitry configured to send a memory operation to the memory system. The memory controller of the memory system includes a cyclic redundancy check (CRC) encoder configured to produce a CRC code using a data word received from the host system; and a Bose-Chaudri-Hocqenghem (BCH) encoder configured to produce a BCH code using the data word and the CRC code. The memory controller is configured to store the data word in the memory array and store the BCH code and the CRC code in the memory array in association with the data word.

In Example 18, the subject matter of Example 17 optionally includes a memory controller configured to store metadata in association with the data word; and optionally includes a BCH encoder is configured to produce the BCH code using the data word, the CRC code, and the metadata.

In Example 19, the subject matter of one or both of Examples 17 and 18 optionally includes a BCH encoder configured to produce an extended BCH code using the data word and the CRC code, wherein the extended BCH code includes a cyclic BCH codeword and at least one parity bit.

In Example 20 the subject matter of one or any combination of Examples 17-19 optionally includes a memory controller configured to read the stored data word in response to a read operation from the host system; read the BCH code and the CRC code stored in association with the data word in response to the read operation; perform error detection on the data word using the BCH code and the CRC code; and send a response to the read operation to the host system according to the error detection.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory system comprising:
a memory array including memory cells that are included in multiple memory dies; and
a memory controller operatively coupled to the memory dies and including:
a cyclic redundancy check (CRC) encoder configured to determine a CRC code using a data word received by the memory controller;
a Bose-Chaudri-Hocqenghem (BCH) encoder configured to determine a BCH code using the data word and the CRC code; and
wherein the memory controller is configured to store the data word in the memory array and store the BCH code and the CRC code in the memory array in association with the data word.

2. The memory system of claim 1, wherein the memory controller is configured to:
prefetch, as part of a read operation, the stored data word and the CRC code and BCH code stored in association with the data word;
perform error detection on the data word using the BCH code and the CRC code; and
send a response to the read operation according to the error detection.

3. The memory system of claim 2, wherein the memory controller includes:
a BCH decoder configured to decode the BCH code stored in association with the data word;
a CRC decoder configured to decode the CRC code stored in association with the data word; and
wherein the memory controller is configured to:
perform error detection on the data word and CRC code using the decoded BCH code; and
perform error detection on the data word using the CRC code when the BCH code indicates no errors in the CRC code.

4. The memory system of claim 2, wherein the memory controller is configured to:
send the data word in the response to the read operation when an error in the data was not detected or when one or more errors were detected and corrected; and
send an error indication in the response to the read operation when an uncorrectable error is detected using the BCH code and CRC code.

5. The memory system of claim 1, wherein the memory controller is configured to:
store the BCH code and the CRC code in one memory die; and
store the data word in one or more different memory die other than memory die storing the BCH code and the CRC code.

6. The memory system of claim 1,
wherein the memory controller is configured to store metadata in association with the data word; and
wherein the BCH encoder is configured to determine the BCH code using the data word, the CRC code, and the metadata.

7. The memory system of claim 1, wherein the BCH encoder is configured to determine an extended BCH code using the data word and the CRC code, wherein the extended BCH code includes a cyclic BCH codeword and a parity bit.

8. The memory system of claim 1, including a communication interface operatively coupled to the memory controller, and wherein the memory controller is configured to receive the data word via the communication interface according to a compute express link (CXL) compatible protocol.

9. A method of operating a memory system, the method comprising:
receiving, by a memory controller of the memory system, a data word from a host system;
determining a cyclic redundancy check (CRC) code using the data word;
determining a BCH code using the data word and the CRC code; and
storing the data word in a memory array of the memory system and storing the BCH code and the CRC code in the memory array in association with the data word.

10. The method of claim 9, including:
prefetching, by the memory controller in response to a read operation from the host system, the data word from the memory array and the BCH code and the CRC code stored in association with the data word;
performing, by the memory controller, error detection on the data word using the BCH code and the CRC code; and
sending a response to the host system according to the error detection.

11. The method of claim 10, wherein the performing the error detection includes:
decoding the BCH code;
performing error detection on the data word and CRC code using the decoded BCH code; and
performing error detection on the data word using the CRC code when the BCH code indicates no errors in the CRC code.

12. The method of claim 10, wherein the sending the response includes:
sending the data word when an error in the data word was not detected or when one or more errors were detected and corrected; and
sending an error response to the host system when an uncorrectable error is detected using the BCH code and CRC code.

13. The method of claim 9, including storing the BCH code and the CRC code in a same memory die.

14. The method of claim 9, including:
storing, by the memory controller, metadata in association with the data word; and
wherein the determining the BCH code includes determining the BCH code using the data word, the CRC code, and the metadata.

15. The method of claim 9,
wherein the determining the BCH code includes determining an extended BCH code using the data word and the CRC code, wherein the extended BCH code includes a cyclic BCH codeword and at least one parity bit.

16. The method of claim 9, including the memory controller receiving the data word from the host system according to a compute express link (CXL) compatible protocol.

17. A computing system comprising:
a memory system including a memory array including memory cells that are included in multiple memory dies, and a memory controller operatively coupled to the memory dies; and
a host system including host processing circuitry configured to send a memory operation to the memory system; and
wherein the memory controller includes:
a cyclic redundancy check (CRC) encoder configured to produce a CRC code using a data word received from the host system;
a Bose-Chaudri-Hocqenghem (BCH) encoder configured to produce a BCH code using the data word and the CRC code; and
wherein the memory controller is configured to store the data word in the memory array and store the BCH code and the CRC code in the memory array in association with the data word.

18. The system of claim 17, including:
wherein the memory controller is configured to store metadata in association with the data word; and
wherein the BCH encoder is configured to produce the BCH code using the data word, the CRC code, and the metadata.

19. The system of claim 17, wherein the BCH encoder is configured to produce an extended BCH code using the data word and the CRC code, wherein the extended BCH code includes a cyclic BCH codeword and at least one parity bit.

20. The system of claim 17, wherein the memory controller is configured to:
read the stored data word in response to a read operation from the host system;
read the BCH code and the CRC code stored in association with the data word in response to the read operation;
perform error detection on the data word using the BCH code and the CRC code; and
send a response to the read operation to the host system according to the error detection.
